(19) United States
(12) Patent Application Publication
(10) Pub. No.: US 2011/0028095 A1
(43) Pub. Date: Feb. 3, 2011

(54) RADIO COMMUNICATION TERMINAL AND DEVICE START METHOD

(75) Inventor: Atsushi Hattori, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/935,622

(22) PCT Filed: Mar. 31, 2009
(86) PCT No.: PCT/JP2009/001490

§ 371 Date: Sep. 30, 2010

(30) Foreign Application Priority Data
Apr. 4, 2008 (JP) 2008-098398

(51) Int. Cl. H04B 7/00

(52) U.S. Cl. 455/41.2

(57) ABSTRACT

Provided is a user-friendly radio communication terminal on which a plurality of radio communication devices are mounted. The radio communication terminal includes a request data information holding unit (103) and a start control unit (105). The request data information holding unit (103) extracts, as request data information, information concerning data to be received by a local terminal, from holding data information concerning the data held by the data transmission terminal. Moreover, the request data information holding unit (103) holds the extracted request data information in a buffer of the request data information holding unit (103). The start control unit (105) starts a second radio communication device (102) for making communication with a data transmission terminal by a second radio communication if an operation on the first radio communication device (101) is detected while the request data information is held in the request data information holding unit (103).

### TECHNICAL FIELD

The present invention relates to a radio communication terminal and a device start method.

### BACKGROUND ART

With the increasing sophistication of radio communication terminals such as mobile phones, radio communication terminal applications such as e-mail and WWW (World Wide Web) access, music distribution, data exchange with a PC (Personal Computer), and navigation using GPS (Global Positioning System) have been implemented, and modes and data used by mobile communication terminals have become more diversified. In order to handle such diversification, a plurality of radio communication devices, including infrared, Bluetooth (registered trademark), and LAN (Local Area Network) devices, have been installed in radio communication terminals.

In the case of a terminal that is constantly supplied with power, such as a PC, all installed radio communication devices and cable communication devices are generally in a started state irrespective of whether or not those devices are being used for communication. Consequently, all the communication devices can receive data at any time. However, in the case of a radio communication terminal such as a mobile phone, radio communication devices other than public network communication devices are stopped in order to extend the continuous operating time with limited battery capacity. Therefore, a problem when transmitting data to a nearby radio communication terminal, for example, is that preparations must be made to start and allow a radio communication device to be used for data communication to be able to receive data.

An example of a conventional technology that deals with this problem is one that starts Bluetooth devices in radio communication terminals using public network communication, and establishes Bluetooth communication (see Patent Document 1, for example).

As shown in FIG. 1, a terminal that requests Bluetooth communication (an initiator terminal) starts a Bluetooth device (ST101), and transmits a Bluetooth communication start request to a communicating-party terminal (acceptor terminal) using public network communication (ST102). On receiving the communication start request from the initiator terminal, the acceptor terminal decides whether or not to accept this communication start request (ST103). If the acceptor terminal accepts the communication start request (ST103: YES), the acceptor terminal starts the Bluetooth device (ST104). Then a Bluetooth connection session is established between the initiator terminal and acceptor terminal, and Bluetooth communication is started (ST105 through ST109).

### Patent Document 1: Japanese Patent Application Laid-Open No. 2003-198673

### DISCLOSURE OF INVENTION

### Problems to be Solved by the Invention

Thus, with the above conventional technology, in order to perform data communication (Bluetooth communication) it is necessary to perform both radio communication device (Bluetooth device) start processing and communication connection (Bluetooth connection session establishment) processing separately. This is time-consuming for a radio communication terminal user wishing to perform data communication, and greatly reduces the user-friendliness of a radio communication terminal.

It is therefore an object of the present invention to provide a radio communication terminal and device start method that improve the user-friendliness of a radio communication terminal in which a plurality of radio communication devices are installed.

### Means for Solving the Problem

A radio communication terminal of the present invention employs a configuration having: a first radio communication device that communicates with a data transmission terminal holding data by means of a first radio communication; a second radio communication device that communicates with the data transmission terminal by means of a second radio communication; an extraction section that extracts information relating to data requested by the radio communication terminal as request data information from holding data information relating to data held by the data transmission terminal; a holding section that holds the request data information; and a control section that starts the second radio communication device if an operation on the first radio communication device is detected while the request data information is being held in the holding section.

A device start method of the present invention is a device start method for a radio communication terminal having a first radio communication device that communicates with a data transmission terminal holding data by means of a first radio communication and a second radio communication device that communicates with the data transmission terminal by means of a second radio communication, and includes the steps of: extracting information relating to data requested by the radio communication terminal as request data information from holding data information relating to data held by the data transmission terminal; holding the request data information; and starting the second radio communication device if an operation on the first radio communication device is detected while the request data information is being held.

### ADVANTAGEOUS EFFECTS OF INVENTION

The present invention improves the user-friendliness of a radio communication terminal in which a plurality of radio communication devices are installed.

### BRIEF DESCRIPTION OF DRAWINGS

FIG. 1 is a drawing showing conventional Bluetooth start processing;

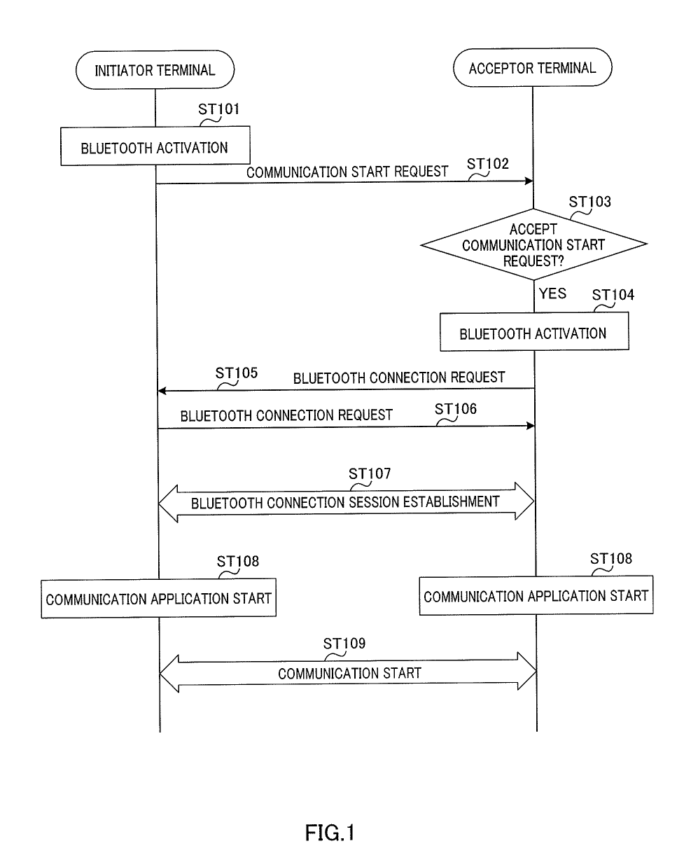

FIG. 2 is a drawing showing a radio communication system that includes a radio communication terminal according to an embodiment of the present invention;

FIG. 3 is a block diagram showing a configuration of a radio communication terminal in this embodiment;

FIG. 4 is a flowchart showing the flow of start control processing of a second radio communication device in this embodiment;

FIG. 5 is a drawing showing request data information before holding data information reception in this embodiment;

FIG. 6 is a flowchart showing the flow of update processing of request data information in this embodiment;

FIG. 7 is a drawing showing holding data information in this embodiment;

FIG. 8 is a drawing showing request data information after holding data information reception in this embodiment; and

FIG. 9 is a drawing showing request data information after completion of data reception in this embodiment.

### BEST MODE FOR CARRYING OUT THE INVENTION

Now, an embodiment of the present invention will be described in detail with reference to the accompanying drawings.

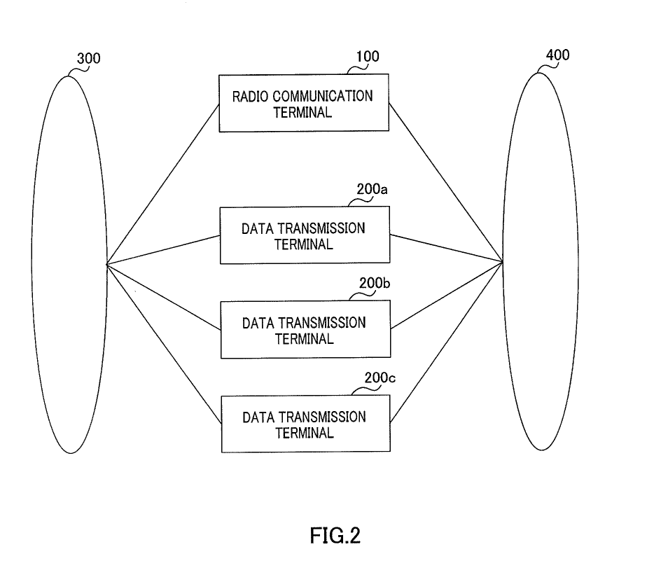

FIG. 2 is a drawing showing a radio communication system that includes a radio communication terminal according to an embodiment of the present invention. The radio communication system shown in FIG. 2 comprises radio communication terminal 100 and data transmission terminals 200a through 200c.

Radio communication terminal 100 has first radio communication device 101 described later herein that communicates with data transmission terminals 200a through 200c by means of radio communication 300, and second radio communication device 102 described later herein that communicates with data transmission terminals 200a through 200c by means of radio communication 400. Another radio communication device that communicates with data transmission terminals 200a through 200c may also be installed in radio communication terminal 100.

Data transmission terminals 200a through 200c are terminals capable of holding data that is transmitted to radio communication terminal 100. Also, data transmission terminals 200a through 200c manage data held by data transmission terminals 200a through 200c, or information relating to data planned to be held (hereinafter referred to as “holding data information”). Data transmission terminals 200a through 200c then report holding data information to radio communication terminal 100 as necessary.

Radio communication 300 is radio communication for performing communication other than data communication. Here, data transmission terminals 200a through 200c report holding data information to radio communication terminal 100 by means of radio communication 300. Radio communication 300 may be the same kind of radio communication as radio communication 400 described later herein, or may be radio communication with a comparatively wide communication range such as public network communication or a wireless LAN, for example.

Radio communication 400 is radio communication for performing data communication. Here, data transmission terminals 200a through 200c transmit held data to radio communication terminal 100 by means of radio communication 400. Radio communication 400 is radio communication with a comparatively narrow communication range such as infrared communication, Bluetooth (registered trademark), or millimeter wave UWB (Ultra Wideband), for example.

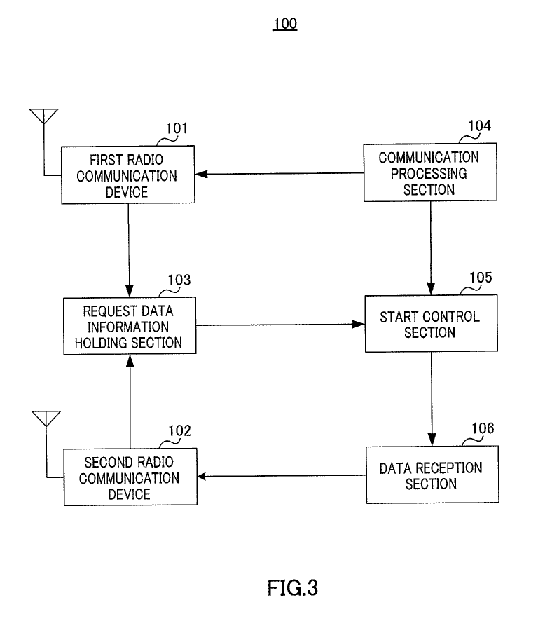

The configuration of radio communication terminal 100 according to this embodiment will now be described. FIG. 3 is a block diagram showing the configuration of radio communication terminal 100 according to this embodiment. In the following description, first radio communication device 101 is always started, whereas second radio communication device 102 is stopped.

First radio communication device 101 is a radio communication device that communicates with data transmission terminals 200a through 200c by means of radio communication 300 as shown in FIG. 2. First radio communication device 101 receives holding data information transmitted from data transmission terminals 200 by means of radio communication 300, and outputs received holding data information to request data information holding section 103.

Second radio communication device 102 is a radio communication device that receives data from data transmission terminals 200a through 200c by means of radio communication 400 as shown in FIG. 2. Second radio communication device 102 receives data transmitted from data transmission terminals 200 by means of radio communication 400, and outputs received data to a buffer (not shown) for data storage of received data.

Request data information holding section 103 receives holding data information reported from data transmission terminals 200a through 200c (FIG. 2) or another terminal (not shown) via first radio communication device 101. Then request data information holding section 103 extracts information relating to data for which radio communication terminal 100 requests reception from received holding data information. Request data information holding section 103 then holds the extracted request data information in a buffer possessed by request data information holding section 103. Here, holding data information is information relating to data held by data transmission terminals 200a through 200c, and holding data information includes at least information identifying the data itself, such as a data file name (data identification information). Holding data information may also include information relating to data contents or the like (attribute information). For example, data identification information and attribute information for data for which radio communication terminal 100 requests reception from among information shown in holding data information is registered beforehand in a buffer by request data information holding section 103 as filtering information. Then, on receiving holding data information from the next time onward, request data information holding section 103 updates the request data information based on the filtering information. Details of request data information update processing by request data information holding section 103 will be given later herein.

Communication processing section 104 performs communication processing for first radio communication device 101, such as first radio communication device 101 startup, or starting communication with data transmission terminals 200a through 200c using first radio communication device 101. That is to say, an operation on first radio communication device 101 is performed by communication processing section 104. When performing an operation on first radio communication device 101, communication processing section 104 outputs control information indicating performance of an operation on first radio communication device 101 to start control section 105.

Based on request data information held by request data information holding section 103 and control information input from communication processing section 104, start control section 105 determines whether or not to start second radio communication device 102. Specifically, in the event of detecting an operation on first radio communication device 101 by means of control information input from communication processing section 104 while request data information is being held in request data information holding section 103, start control section 105 performs control to start second radio communication device 102. Then start control section 105 outputs a second radio communication device start control result to data reception section 106. Details of start control processing by start control section 105 will be given later herein.

If a control result input from start control section 105 indicates that second radio communication device 102 is to be started, data reception section 106 starts second radio communication device 102. Then data reception section 106 performs data reception processing that receives data from data transmission terminal 200 via second radio communication device 102. If data reception is cut—that is, if a radio connection with data transmission terminal 200 by means of radio communication 400 is cut—data reception section 106 stops second radio communication device 102.

Start control processing by start control section 105 will now be described in detail. Here, a case will be described in which radio communication terminal 100 and data transmission terminal 200a in FIG. 2 communicate.

As stated above, start control section 105 starts second radio communication device 102 in the event of detecting an operation on first radio communication device 101 while request data information is being held in request data information holding section 103.

To prevent unnecessary starting of second radio communication device 102, start control section 105 further determines whether or not to start second radio communication device 102 using the following two methods.

As the first method, in the event of detecting an operation on first radio communication device 101, start control section 105 determines whether or not to start second radio communication device 102 based on whether or not data transmission terminal 200a to be communicated with by means of an operation on first radio communication device 101 is included in request data information. That is to say, start control section 105 determines whether or not data transmission terminal 200a is holding data indicated by the request data information. Here, request data information includes information relating to a data transmission terminal holding data (a data holding terminal) in addition to above-described data identification information and attribute information. Identification information for data transmission terminal 200 communicated with by using first radio communication device 101 may be a network address of data transmission terminal 200 or a terminal name obtained from data transmission terminal 200. Also, if first radio communication device 101 is an infrared device and communication processing section 104 performs an infrared remote control operation, start control section 105 may determine data transmission terminal 200 with which communication is performed by means of an operation on first radio communication device 101 from the infrared remote control operation contents.

Then start control section 105 determines whether or not data transmission terminal 200a communicated with by means of an operation on first radio communication device 101 and the data holding terminal indicated by the request data information match. For example, when radio communication terminal 100 starts communication with data transmission terminal 200a using first radio communication device 101, start control section 105 starts second radio communication device 102 if data transmission terminal 200a is included in the request data information. On the other hand, if data transmission terminal 200a is not included in the request data information, start control section 105 does not start second radio communication device 102.

In this way, when an operation is performed on first radio communication device 101, start control section 105 starts second radio communication device 102 only if data transmission terminal 200a communicated with by using first radio communication device 101 is included in the request data information. That is to say, second radio communication device 102 starts only if an operation on first radio communication device 101 is performed for data transmission terminal 200a holding data for which radio communication terminal 100 requests reception.

As the second method, in the event of detecting an operation on first radio communication device 101, start control section 105 determines whether or not to start second radio communication device 102 based on a time specified by holding data information. Specifically, in the event of detecting an operation on first radio communication device 101, start control section 105 starts second radio communication device 102 only if a time specified by the holding data information has passed. In other words, even if an operation on first radio communication device 101 is detected, start control section 105 does not start second radio communication device 102 if a time specified by the holding data information has not passed. Here, data transmission terminals 200a through 200c include a scheduled time for holding data (scheduled holding time) in holding data information as a data holding condition, and radio communication terminal 100 adds a data holding condition included in received holding data information to request data information. If data transmission terminals 200a through 200c are already holding data, they may indicate that they are holding data as a data holding condition, and if a scheduled holding time has not been fixed, they may indicate that a data holding schedule has not been fixed as a data holding condition.

Start control section 105 calculates the earliest scheduled holding time (time for first holding data) from among scheduled holding times indicated in request data information held by request data information holding section 103. Then start control section 105 starts second radio communication device 102 only if the calculated time has passed. In other words, start control section 105 does not start second radio communication device 102 until the calculated time.

Thus, in the event of an operation on first radio communication device 101, radio communication terminal 100 starts second radio communication device 102 only if data transmission terminal 200a holds data included in the request data information.

Start control section 105 may also combine the first method and the second method. In this case, in the event of an operation on first radio communication device 101, start control section 105 does not start second radio communication device 102 if data transmission terminal 200a is not included in the request data information. On the other hand, if data transmission terminal 200a is included in the request data information, start control section 105 calculates a scheduled holding time for first holding data for each data transmission terminal 200 included in the request data information. Here, the scheduled holding times calculated for each data transmission terminal 200 are different. Then start control section 105 starts termination sequence generation section 210 in the event of detecting an operation on first radio communication device 101 at or after the scheduled holding time for data transmission terminal 200a among the scheduled holding times calculated for each data transmission terminal.

In this way, in the event of an operation on first radio communication device 101, second radio communication device 102 is started only if data transmission terminal 200a is included in the request data information and if the time is not earlier than the scheduled holding time for data transmission terminal 200a to hold data. That is to say, radio communication terminal 100 starts second radio communication device 102 when the counterparty of an operation on first radio communication device 101 is data transmission terminal 200a holding or scheduled to hold data for which reception is requested, and at or after a time at which data transmission terminal 200a actually holds data, thereby reducing unnecessary starts of second radio communication device 102.

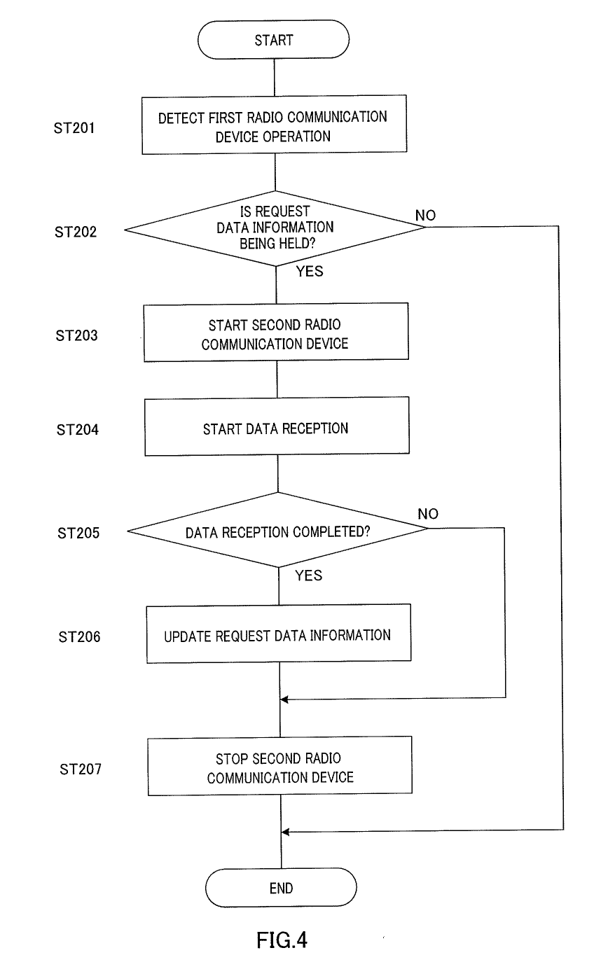

Start control processing by start control section 105 will now be described using the flowchart shown in FIG. 4.

In step (hereinafter referred to as “ST”) 201, start control section 105 detects an operation on first radio communication device 101 by means of control information from communication processing section 104.

In ST202, start control section 105 determines whether or not request data information relating to data transmission terminal 200a data is being held in request data information holding section 103.

If request data information relating to data transmission terminal 200a is being held in request data information holding section 103 (ST202: YES), in ST203 start control section 105 starts second radio communication device 102. That is to say, start control section 105 commands data reception section 106 to start second radio communication device 102.

In ST204, data reception section 106 starts second radio communication device 102, and starts data reception from data transmission terminal 200a by means of radio communication 400.

If all data reception has been completed (ST205: YES), in ST206 request data information holding section 103 updates request data information that is held. Specifically, request data information holding section 103 information corresponding to data for which all data reception has been completed is deleted from the request data information. On the other hand, if all data reception has not been completed (ST205: NO), request data information holding section 103 does not update request data information that is held.

In ST207, data reception section 106 stops second radio communication device 102 after the radio connection with data transmission terminal 200a by means of radio communication 400 has been cut.

On the other hand, if request data information relating to data transmission terminal 200a is not being held in request data information holding section 103 (ST202: NO), start control section 105 does not start second radio communication device 102.

In this way, it is possible for radio communication terminal 100 to start a second radio communication device automatically by starting communication with data transmission terminal 200a by means of an operation on first radio communication device 101. That is to say, radio communication terminal 100 may make a request to a data transmission terminal for data communication using second radio communication device 102 by means of an operation on first radio communication device 101. By this means, second radio communication device 102 is started automatically if data transmission terminal 200a is included in the request data information, making it possible for the radio communication terminal 100 user to perform data reception using second radio communication device 102 without being aware of second radio communication device 102 startup. Also, second radio communication device 102 is not started if data transmission terminal 200a is not included in the request data information. Consequently, it is possible for radio communication terminal 100 to suppress unnecessary power consumption.

Next, a case will be described in which the radio communication system shown in FIG. 2 is applied to a system in which a mobile phone receives a recorded program from a television. In the following description, a system comprising a mobile phone and two televisions is described. Here, radio communication terminal 100 shown in FIG. 2 is assumed to be a mobile phone, and data transmission terminals 200a and 200b shown in FIG. 2 are assumed to be television 1 and television 2.

It is desirable here for second radio communication device 102 to use a radio communication method capable of high-speed communication, and millimeter wave UWB communication, for example, is a possible radio communication method. Thus, in the following description, as an example, radio communication terminal 100 (the mobile phone) has an infrared communication device as first radio communication device 101, and a millimeter wave UWB communication device as second radio communication device 102. That is to say, radio communication 300 is infrared communication, and radio communication 400 is millimeter wave UWB communication. Infrared remote control operations are performed by communication processing section 104 of radio communication terminal 100 (the mobile phone). Data transmission terminal 200a (television 1) and data transmission terminal 200b (television 2) also have an infrared communication device and a millimeter wave UWB communication device, in the same way as radio communication terminal 100.

Here, if first radio communication device 101 is an infrared communication device and second radio communication device 102 is a millimeter wave UWB communication device, both are directional radio devices. Also, there is a high possibility that a communicating party communicated with by using first radio communication device 101 (the infrared communication device) and a communicating party communicated with by using second radio communication device 102 (the millimeter wave UWB communication device) will be the same. Consequently, in order to enable radio communication terminal 100 to communicate by means of millimeter wave UWB communication with data transmission terminals 200 that communicate by means of infrared communication, provision may be made for radio directivity to have the same direction for first radio communication device 101 (the infrared communication device) and second radio communication device 102 (the millimeter wave UWB communication device). It is therefore desirable for the radio communication devices to be at the tip of radio communication terminal 100 (the mobile phone) so as to perform radio communication in the same direction.

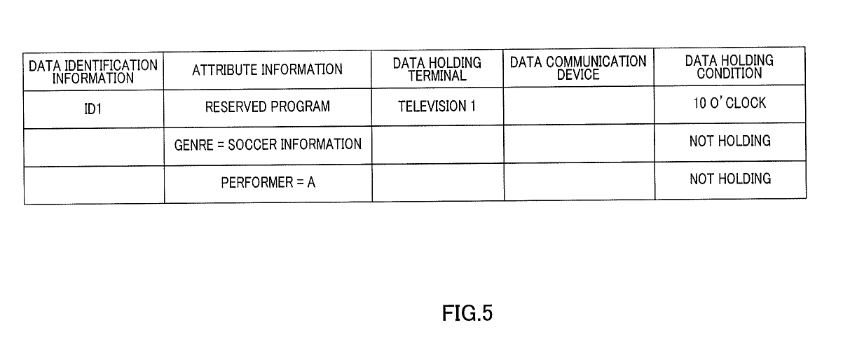

Request data information holding section 103 of radio communication terminal 100 (the mobile phone) holds the request data information shown in FIG. 5. Specifically, as shown in FIG. 5, the request data information comprises data identification information identifying the data itself, attribute information indicating data contents, “data holding terminal” indicating a terminal holding the data, “data communication device” indicating a device to be used for data communication (for example, a millimeter wave UWB device, a wireless LAN device, or the like), and “data holding condition” indicating a data holding condition in each data transmission terminal 200 (television). For example, as shown in FIG. 5, request data information held by request data information holding section 103 at a certain time is indicated by three kinds of data for which radio communication terminal 100 requests reception. For example, the first request data information is request data information registered in data transmission terminal 200a (television 1) when program-recording programming was performed, for which, as shown in FIG. 5, data identification information=“ID1,” attribute information=“reserved program,” data holding terminal=“television 1,” and data holding condition=“10 o'clock.” The remaining two request data information items shown in FIG. 5 are request data information indicating attribute information (genre, performer) for content registered in the mobile phone, with attribute information (genre, performer)=“soccer information” and a program in which “A” appears, and data holding condition=“not holding.” Here, ‘data holding condition=“10 o'clock”’ indicates that program programming is to be completed at 10 o'clock, and ‘data holding condition=“not holding”’ indicates a condition in which a data transmission terminal (television) is not holding data. When data transmission terminal 200 is holding data, “holding” is shown for “data holding condition.”

For example, if the time is before 10 o'clock, data indicated in the request data information is not being held in either data transmission terminal 200a (television 1) or data transmission terminal 200b (television 2). Consequently, start control section 105 in radio communication terminal 100 does not start a millimeter wave UWB communication device even if an infrared remote control operation is performed on data transmission terminal 200a (television 1), for instance, in the state shown in FIG. 5.

Here, request data information held by request data information holding section 103 is updated each time holding data information transmitted from data transmission terminal 200a (television 1), data transmission terminal 200b (television 2), or another terminal (such as a home-appliance management server, for example), is received. In order to allow radio communication terminal 100 (the mobile phone) to receive holding data information, the IP address or mail address of radio communication terminal 100 may be registered beforehand in each data transmission terminal 200 (for example, television 1 and television 2) that transmits holding data information, for example.

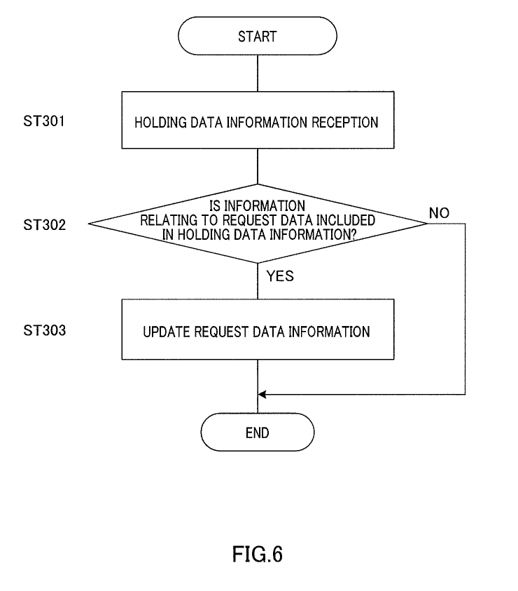

Request data information update processing by request data information holding section 103 will now be described in detail using the flowchart in FIG. 6.

In ST301, request data information holding section 103 receives holding data information from data transmission terminal 200 (a television) by means of radio communication 300 (infrared communication). In ST302, request data information holding section 103 determines whether or not information relating to request data of radio communication terminal 100 is included in the holding data information received in ST301.

If information relating to request data of radio communication terminal 100 is included in the received holding data information (ST302: YES), in ST303 request data information holding section 103 extracts information relating to request data of radio communication terminal 100 from the information indicated in the holding data information, and updates the held request data information. On the other hand, if information relating to request data of radio communication terminal 100 is not included in the received holding data information (ST302: NO), request data information holding section 103 does not update the held request data information.

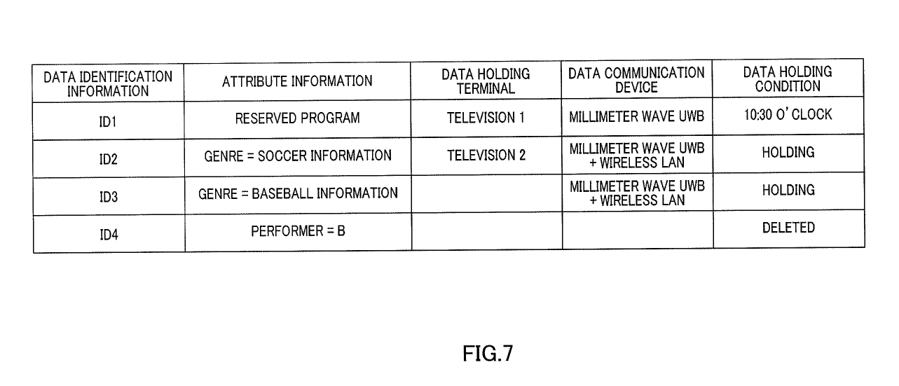

FIG. 7 shows an example of holding data information. The format of the holding data information shown in FIG. 7 is the same as the format of the request data information shown in FIG. 5. The holding data information shown in FIG. 7 indicates that three kinds of data (ID1, ID2, and ID3) are held by data transmission terminals 200 (television 1 or television 2), and one kind of data (ID4) has been deleted by one of data transmission terminals 200. Here, ID1 data indicates that the scheduled data holding time is 10:30 o'clock, and ID3 data indicates that there is no information identifying a data holding terminal.

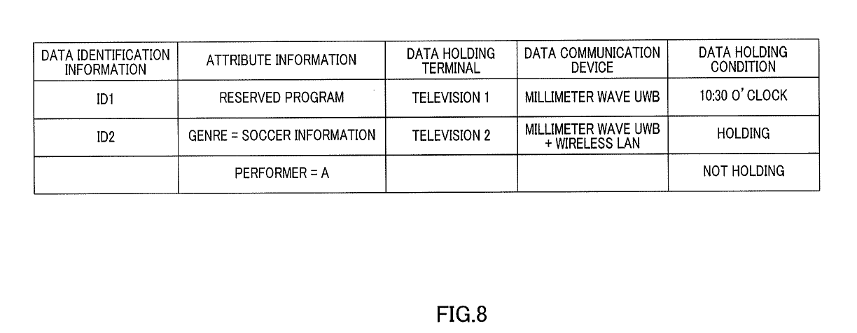

On receiving the holding data information shown in FIG. 7, request data information holding section 103 updates the held request data information (FIG. 5). Comparing FIG. 5 and FIG. 7 here, since ID1 shown in FIG. 7 is included in the request data information shown in FIG. 5, of the holding data information shown in FIG. 7, request data information holding section 103 reflects the ID1 information in the ID1 information shown in FIG. 5. Also, since ID2 shown in FIG. 7 matches attribute information (genre=“soccer information”) shown in FIG. 5, of the holding data information shown in FIG. 7, request data information holding section 103 reflects the ID2 information in information for which attribute information is ‘genre=“soccer information”’ shown in FIG. 5. Specifically, as shown in FIG. 8, for ID1, “millimeter wave UWB” is added to “data communication device,” and data holding information is updated to “10:30 o'clock.” Also, for ID2, “television 2” is added to “data holding terminal,” “millimeter wave UWB+wireless LAN” is added to “data communication device,” and “holding” is added to “data holding condition.” On the other hand, since ID3 attribute information shown in FIG. 7 is not included in any request data information shown in FIG. 5, request data information holding section 103 does not reflect ID3 information in the request data information.

Here, a case will be described in which, for example, communication processing section 104 performs an infrared remote control operation on data transmission terminal 200a (television 1) while the request data information shown in FIG. 8 is held in request data information holding section 103. First, start control section 105 identifies data transmission terminal 200a (television 1) as the communicating party from the infrared remote control operation contents. Then start control section 105 determines whether or not to start the millimeter wave UWB communication device based on whether or not data transmission terminal 200a (television 1) is holding data for which reception is requested. Here, from the request data information shown in FIG. 8, if the time is later than 10:30 o'clock data transmission terminal 200a (television 1) is holding reserved-program data, and therefore start control section 105 starts the millimeter wave UWB communication device. Then data reception section 106 starts communication with data transmission terminal 200a (television 1) by means of millimeter wave UWB communication, and receives reserved-program data identified by ID1.

Similarly, a case will be described in which communication processing section 104 performs an infrared remote control operation on data transmission terminal 200b (television 2) while the request data information shown in FIG. 8 is being held in request data information holding section 103. First, start control section 105 identifies data transmission terminal 200b (television 2) as the communicating party from the infrared remote control operation contents. Then start control section 105 determines whether or not to start the millimeter wave UWB communication device based on whether or not data transmission terminal 200b (television 2) is holding data for which reception is requested. That is to say, since, from the request data information shown in FIG. 8, data transmission terminal 200b (television 2) is already holding data identified by ID2, start control section 105 starts the millimeter wave UWB communication device.

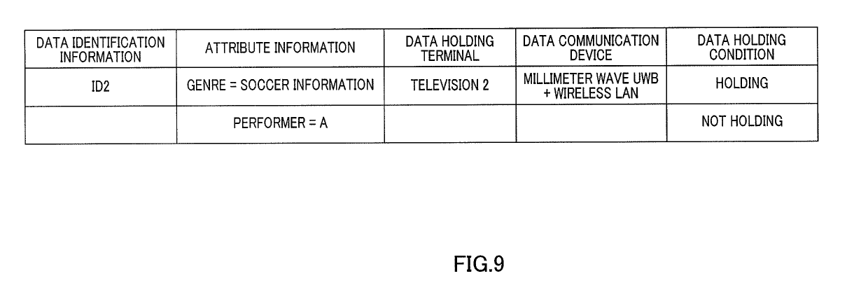

After data reception from data transmission terminal 200 (a television) is completed, data reception section 106 stops the millimeter wave UWB communication device. Also, request data information holding section 103 updates the request data information. For example, upon completion of reception of data of a reserved program identified by ID1 from data transmission terminal 200a (television 1) while the request data information shown in FIG. 8 is being held in request data information holding section 103, request data information holding section 103 deletes ID1 information from the request data information, as shown in FIG. 9.

Radio communication terminal 100 (the mobile phone) may also be provided with a notification section (not shown) that gives notification of whether or not data reception has been completed. Sound, light, vibration, or the like, for example, may be used as a notification method. For instance, when second radio communication device 102 (a millimeter wave UWB device, for example) is started and data reception is completed, or when data reception has failed, the notification section indicates that fact on the standby screen or the like of radio communication terminal 100 (the mobile phone). By this means, it is possible for the user of radio communication terminal 100 (the mobile phone) to be notified promptly of the situation regarding data reception.

Thus, according to this embodiment, a radio communication terminal starts a second radio communication device for data reception in the event of detecting an operation on a first radio communication device for a data transmission terminal while request data information indicating information relating to data for which reception is requested is held in radio communication terminal 100. That is to say, the radio communication terminal is able to start the second radio communication device automatically only by operating the first radio communication device. Thus, the radio communication terminal user need only perform communication processing for data reception (for example, processing that makes a request for reception by means of an infrared remote controller to a data transmission terminal that holds data), without being aware of startup of the second radio communication device. Consequently, the radio communication terminal user can be spared a time-consuming procedure for performing data communication. Thus, according to this embodiment, the user-friendliness of a radio communication terminal can be improved.

Also, according to this embodiment, a radio communication terminal starts a second radio communication device only if a data transmission terminal is holding data. In this way, startups of the second radio communication device when a data transmission terminal is not holding data—that is, in a situation in which data reception is not possible—can be reduced, thereby reducing unnecessary power consumption. Furthermore, in this embodiment, the second radio communication device is stopped after data reception has been completed. By this means, periods during which the second radio communication device is started can be limited to times of data reception only, further reducing power consumption.

In this embodiment, a case has been described in which radio communication terminal 100 receives holding data information using first radio communication device 101. However, with the present invention, a radio communication device used for reception of holding data information is not limited to first radio communication device 101, and may also be either second radio communication device 102 or another communication device (not shown). For example, if second radio communication device 102 has been started, radio communication terminal 100 may receive holding data information using second radio communication device 102.

In this embodiment, a case has been described in which request data information holding section 103 extracts information relating to data for which reception is requested as request data information from holding data information reported from a data transmission terminal, and holds the extracted request data information. However, with the present invention, request data information holding section 103 may also hold received holding data information itself as request data information.

In this embodiment, a case has been described in which there is one second radio communication device 102. However, the present invention can also be applied to a case in which there are two or more second radio communication devices 102. In this case, of the plurality of second radio communication devices 102, second radio communication device 102 that can be used for data reception is specified beforehand based on holding data information. Then provision may be made for data reception section 106 of radio communication terminal 100 to start second radio communication device 102 specified beforehand when start control section 105 starts second radio communication device 102. Also, second radio communication device 102 reported from data transmission terminal 200 communicated with via first radio communication device 101 may be started. By this means, it is possible for second radio communication device 102 to be selected by radio communication terminal 100 according to the communication conditions, making data reception from data transmission terminal 200 more reliable.

In general, the communication method of first radio communication device 101 and the communication method of second radio communication device 102 are different, and therefore their communication characteristics, and in particular the communication ranges of the respective communication methods, are different. Thus, the communication method of first radio communication device 101 and the communication method of second radio communication device 102 may be selected so that the communication range of second radio communication device 102 encompasses the communication range of first radio communication device 101. Also, communication output may be set for the respective radio communication devices so that the communication range of second radio communication device 102 encompasses the communication range of first radio communication device 101. By this means, for example, if communication with data transmission terminal 200a is possible using first radio communication device 101, communication with data transmission terminal 200a is also possible for radio communication terminal 100 using second radio communication device 102. Therefore, as described in the above embodiment, it is possible for radio communication terminal 100 to perform data reception dependably by means of second radio communication device 102 by starting second radio communication device 102 in the event of detecting an operation on first radio communication device 101 while request data information is being held in radio communication terminal 100. It is thus possible to suppress unnecessary starting of second radio communication device 102.

In this embodiment, a case has been described in which second radio communication device 102 is started if a data holding terminal is included in request data information at the time of an operation on first radio communication device 101 (for example, at the time of an infrared remote control operation). However, with the present invention, if a data holding terminal is not included in request data information at the time of an operation on first radio communication device 101 (at the time of an infrared remote control operation), or if a communicating party cannot be identified from the contents of an operation on first radio communication device 101 (an infrared remote control operation), start control section 105 may start second radio communication device 102 (for example, a millimeter wave UWB device) as long as at least one data item is included in the request data information. For example, if a data transmission terminal holding ‘attribute information=“soccer information”’ shown in FIG. 5 is unknown, start control section 105 starts second radio communication device 102 (a millimeter wave UWB device) irrespective of the object of an operation on first radio communication device 101 (infrared remote control operation).

In this embodiment, a case has been described in which a radio communication terminal identifies a data holding condition of a data transmission terminal based on holding data information reported from the data transmission terminal. However, with the present invention, a radio communication terminal may, for example, make an inquiry concerning data held by a data transmission terminal to the data transmission terminal. Then a second radio communication device may be started if it is confirmed that the data transmission terminal is holding data matching the request data information. Also, if it can be determined that a data transmission terminal is holding data for which reception is requested, a radio communication terminal may request data reception by specifying the data for which reception is requested. Furthermore, if a data transmission terminal repeats broadcasting data, a radio communication terminal may start a second radio communication device for receiving data and receive the data being broadcast.

The disclosure of Japanese Patent Application No. 2008-098398, filed on Apr. 4, 2008, including the specification, drawings and abstract, is incorporated herein by reference in its entirety.

### INDUSTRIAL APPLICABILITY

The present invention has an effect of being able to improve the user-friendliness of a radio communication terminal in which a plurality of radio communication devices are installed, and is suitable for use in a mobile communication system or the like.

1. A radio communication terminal comprising:
a first radio communication device that communicates with a data transmission terminal holding data by means of a first radio communication;
a second radio communication device that communicates with the data transmission terminal by means of a second radio communication;
an extraction section that extracts information relating to data requested by the radio communication terminal as request data information from holding data information relating to data held by the data transmission terminal;
a holding section that holds the request data information; and
a control section that starts the second radio communication device if an operation on the first radio communication device is detected while the request data information is being held in the holding section.

2. The radio communication terminal according to claim 1, wherein the holding data information is reported from the data transmission terminal.

3. The radio communication terminal according to claim 1, wherein the control section starts the second radio communication device only if a data transmission terminal communicated with by means of the operation is included in the request data information.

4. The radio communication terminal according to claim 1, wherein the control section starts the second radio communication device only if a time specified by the holding data information has passed.

5. The radio communication terminal according to claim 1, further comprising a notification section that gives notification of whether or not data reception by the second radio communication device has been completed.

6. The radio communication terminal according to claim 1, wherein:
the first radio communication is infrared remote control communication; and
the control section determines a data transmission terminal communicated with by using the second radio communication device based on infrared remote control operation contents.

7. The radio communication terminal according to claim 1, wherein the second radio communication is millimeter wave ultra wideband communication.

8. The radio communication terminal according to claim 1, wherein radio directivity of the first radio communication device and radio directivity of the second radio communication device have the same direction.

9. A device start method for a radio communication terminal having a first radio communication device that communicates with a data transmission terminal holding data by means of a first radio communication and a second radio communication device that communicates with the data transmission terminal by means of a second radio communication, the device start method comprising the steps of:
extracting information relating to data requested by the radio communication terminal as request data information from holding data information relating to data held by the data transmission terminal;
holding the request data information; and
starting the second radio communication device if an operation on the first radio communication device is detected while the request data information is being held.
